(19) United States
(12) Patent Application Publication
(10) Pub. No.: US 2010/0050959 A1
(43) Pub. Date: Mar. 4, 2010

(54) Equine Therapeutic Leg Wraps

(76) Inventor: CRYSTAL H. MCPEAK-YOUNG, CLARESHOLM (CA)

Correspondence Address: Maxey Law Offices, PLLC, 13630 58TH ST. NORTH, SUITE 101, CLEARWATER, FL, 33760, US

(21) Appl. No.: 12/552,038

(22) Filed: Sep. 1, 2009

Related U.S. Application Data
(60) Provisional application No. 61/093,635, filed on Sep. 2, 2008.

(51) Int. Cl. A01K 29/00

(52) U.S. Cl. 119/850

(57) ABSTRACT

Front and rear leg wraps for applying cold or heat compressive therapy to the legs of a horse are provided. Each include a series of horizontally extending pockets along the length of the wrap. The pockets are fitted with refrigerant bags containing a quantity of refrigerant material. The quantity of refrigerant material contained in the refrigerant bags can be varied to control the amount of cold or heat therapy is applied. The front and rear leg wraps include gussets to permit the wraps to closely conform to the complex anatomy of the horse legs.

### CROSS-REFERENCE TO RELATED APPLICATIONS

This application claims the benefit of U.S. Provisional Application No. 61/093,635, filed Sep. 2, 2008, the entirety of which is incorporated herein by reference.

### FILED OF THE INVENTION

The present invention relates generally to therapeutic devices for the legs of animals, and more particularly, relating to cooling or heating compressive wraps for the legs of a horse having an improved construction.

### BACKGROUND OF THE INVENTION

It is desirable to apply a hot compressive force or a cold compressive force to the legs of a horse depending upon the required treatment. There exists numerous devices of a myriad of constructions for either applying compressive force along or in combination with cold or heat therapy. However, there remains a need for a leg wrap of an improved construction that is configured to wrap around and conform to the complex anatomy of the front and rear legs of a horse and to apply either cold or heat therapy to the leg.

### SUMMARY OF THE INVENTION

The preferred embodiments of the present invention addresses this need by providing equine therapeutic leg wraps, each of an improved construction and specifically configured for either the front or rear leg of a horse, and a novel arrangement of refrigerant material that more closely conforms to the different complex anatomy of the front and rear legs.

To achieve these and other advantages, in general, in one aspect, an equine therapeutic leg wrap for applying either cold or hot compressive therapy to an animal's limb, is provided. The equine theraputic leg wrap includes an elongated wrap of a flexible material configured to encircle an animal's limb. The elongated wrap has a series of transversely extending and longitudinally juxtaposed slender pockets. The elongated wrap including further includes one or more longitudinally extending gussets located intermediate the longitudinal side edges of said elongated wrap. A plurality of refrigerant bags of a slender construction and of a flexible material contain a quantity of refrigerant material sealed therein. A single refrigerant bag extending lengthwise in each of said pockets. A series of transversely extending and longitudinally spaced straps are each attached at one end to said elongated wrap and terminating at a free end and are of a length to encircle said animal's limb. Each strap and the elongated wrap has complementary hook-and-loop fasteners for releasably securing said free end of each of said strap to said elongated wrap to secure said elongated wrap to said animal's limb. The quantity by weight of said refrigerant material in contained in each of said refrigerant bags ranges from a high weight of refrigerant material to a low weight of refrigerant material. The refrigerant bag containing the highest weight of refrigerant material is located at a top of said series of pockets, and the refrigerant bag containing the lowest weight of refrigerant material located at a bottom of said series of pockets.

In general, in another aspects, each of said refrigerant bags can be divided into separate and vertically sealed longitudinally extending compartments. The one or more longitudinally extending gussets can include a pair of bottom gussets transversely spaced and longitudinally aligned and being located approximate a bottom end of said elongated wrap. The one or more longitudinally extending gussets can further include a transversely centered gusset positioned above said pair of bottom gussets, and a pair of top gussets transversely spaced and longitudinally aligned and being located approximate a top end of said elongated wrap. The pair of top gussets can extend from said top end of said elongated wrap. The refrigerant material can be of a gel material. The refrigerant bag containing the highest weight of refrigerant material can contain 200 grams of said refrigerant material, and said refrigerant bag containing the lowest weight of refrigerant material can contain 150 grams of said refrigerant material. The refrigerant bag containing the highest weight of refrigerant material can contain 180 grams of said refrigerant material, and said refrigerant bag containing the lowest weight of refrigerant material can contain 90 grams of said refrigerant material. The elongated wrap can be about 73 cm in height, and can be about 56 cm in width when laid open. The elongated wrap can be about 87 cm in height, and can be about 74 cm in width when laid open.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a diagrammatic environment view of equine therapeutic leg wraps in use and applied to the front and rear legs of a horse;

FIG. 2 is a diagrammatic laid open view of a front-right leg wrap;

FIG. 3 is a diagrammatic laid open view of a rear-right leg wrap;

FIG. 4 is a diagrammatic illustration of a refrigerant bag;

FIG. 5 is a diagrammatic illustration of the cross-section section of a refrigerant bag taken along line 6-6 in FIG. 4;

FIG. 6 a simplified diagrammatic illustration of front leg wrap; and

FIG. 7 is a simplified diagrammatic illustration of a rear leg wrap.

### DETAILED DESCRIPTION OF THE INVENTION

FIG. 1 is a diagrammatic environmental view of equine therapeutic front and rear leg wraps 10 and 10′, respectively, of the invention. The leg wraps 10 and 10′ are illustrated in use and secured to the front and rear leags 14 and 16, respectively, of a horse 18.

In FIG. 2, there is shown a front-right leg wrap 10 laid open and viewn from the exterior, the front-left wrap being a mirror image thereof. In FIG. 3, there is shown a rear-right leg wrap 10′ laid open and viewn from the exterior, the rear-left wrap being a mirror image thereof. The front leg wrap 10 is of a length to extend from the radius/ulna or the forearm down and around the coronary band and the bulbs of the heels. In an embodiment, the front leg wrap 10 is about 73 cm in length, and about 56 cm in width when laid open. The rear leg wrap 10′ is of a length to extend from the tibia/fibula or gaskin muscle to the coronary band and the bulbs of the heels. In an embodiment, the rear leg wrap 10′ is about 87 cm in height, and about 74 cm in width when laid open.

Legs wraps 10 and 10′ comprise an elongated wrap of a flexible material configured to encircle the front and rear legs, respectively, of a horse. Leg wraps 10 and 10′ defining a series of transversely extending and longitudinally juxtaposed slender pockets 20. Pockets 20 positioned side-by-side along the length or height of leg wraps 10 and 10′ from a top end 22 and to a bottom end 24. Separate and individual refrigerant bags 26 are disposed one in each pocket 20, and extend lengthwise within the pocket it is disposed.

A series of transversely extending and longitudinally spaced straps 28 are attached at one end 30 to wraps 10 and 10′ and terminating at a free end 32. Straps 28 are of a length to encircle the animal's limb. The straps 28 and wraps 10 and 10′ having complementary hook-and-loop fasteners (hook portion 34 and loop portion 36) for releasably securing the free end 32 of each of strap to the wrap 10 and 10′ in order to secure wrap 10 and 10′ to leg of the horse. The locations hook portions 34 and the loop portions 36 can be interchanged.

In FIG. 2, wrap 10 includes a pair of bottom gussets 38. Bottom gussets 38 are positioned between longitudinal side edges 40 and 42 of wrap 10, and are transversely spaced and longitudinally aligned. Bottom gussets 38 are located approximate bottom end 24 of wrap 10. Bottom gussets 38 permit wrap 10 to closely conform to the bottom region about the hoof and bulbs of the heal of front leg 14 of a horse to which the wrap 10 is applied. Additionally, wrap 10 includes a pair of opposed and obliquely arranged edge gussets 39.

In FIG. 3, likewise, wrap 10′ includes a pair of bottom gussets 38. Bottom gussets 38 are positioned between longitudinal side edges 40 and 42 of wrap 10, and are transversely spaced and longitudinally aligned. Bottom gussets 38 are located approximate bottom end 24 of wrap 10. Bottom gussets 38 permit wrap 10 to closely conform to the bottom region about the hoof and bulbs of the heal of rear leg 16 of a horse to which the wrap 10′ is applied. Additionally, wrap 10′ includes a transversely centered gusset 44 positioned above the pair of bottom gussets 38. Additionally, wrap 10′ includes a pair of top gussets 46 transversely spaced and longitudinally aligned. Top gussets 46 are located approximate a top end 22 of wrap 10′.

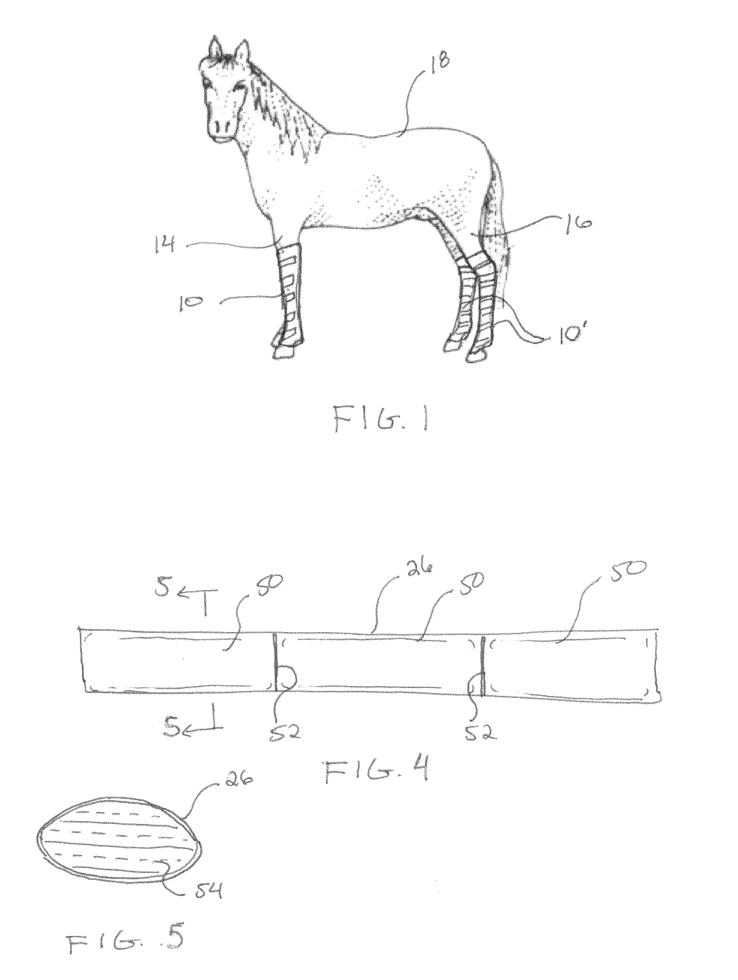

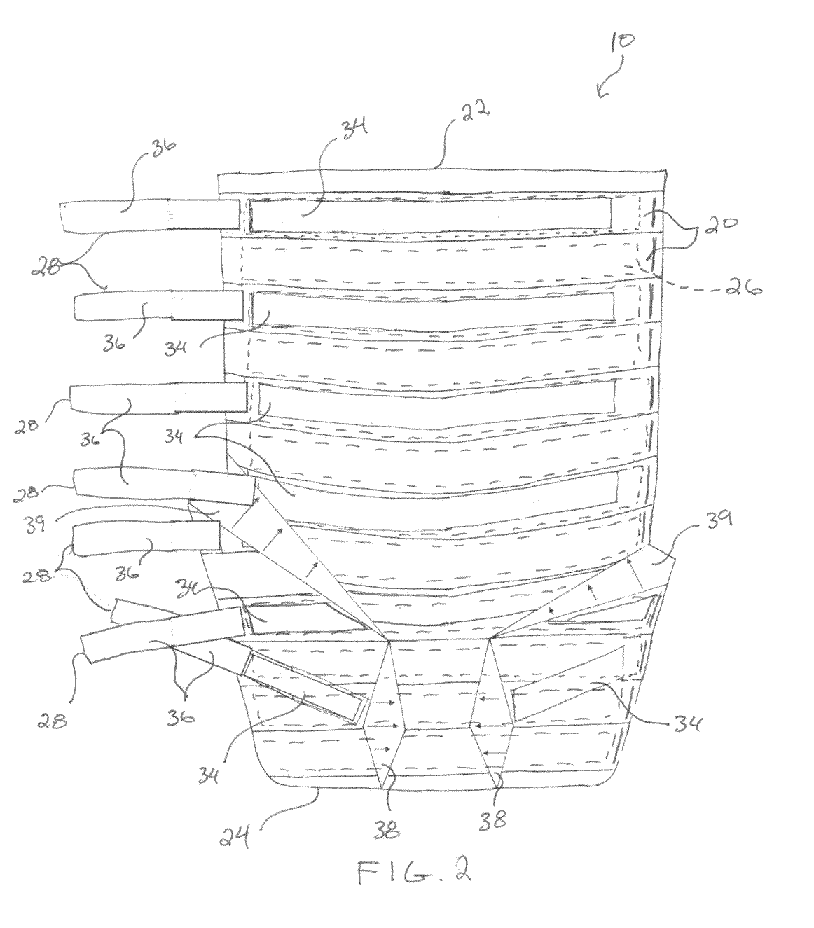

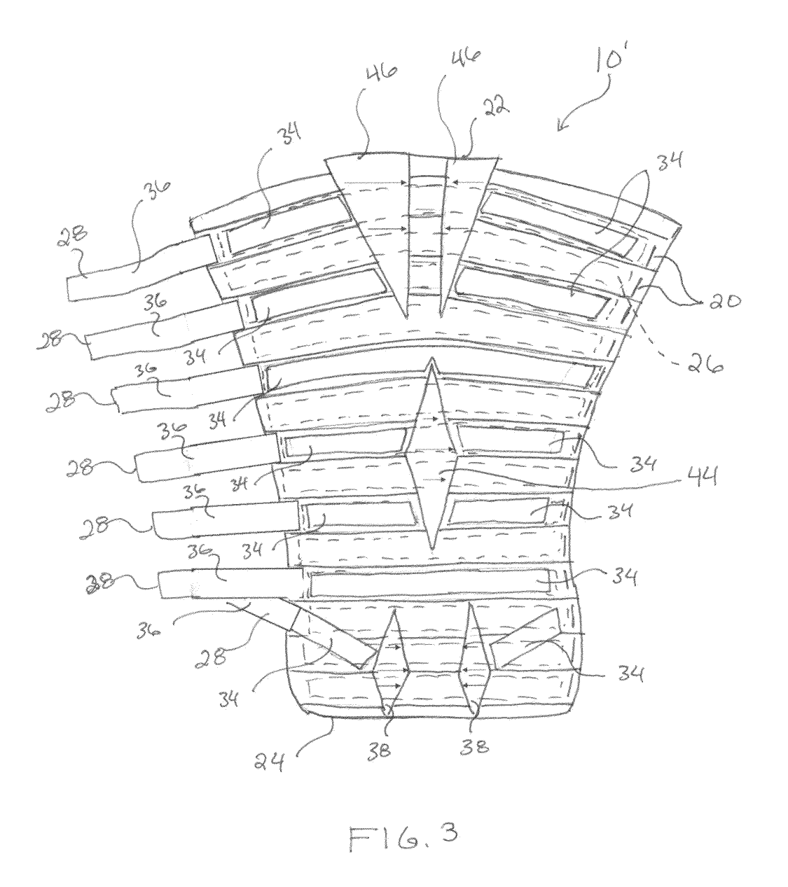

FIG. 4 is a diagrammatic illustration of a refrigerant bag 26. Refrigerant bag 26 is elongated and slender and is constructed of a flexible material permitting the refrigerant bag to be wrapped around the leg of horse. The refrigerant bag 26 can be divided longitudinally into a plurality of separate compartments 50. Compartments 50 are divided by vertical seams or welds 52. Welds 52 provide a vertical fold which further permits the refrigerant bag 26 to fold around or encircle the leg.

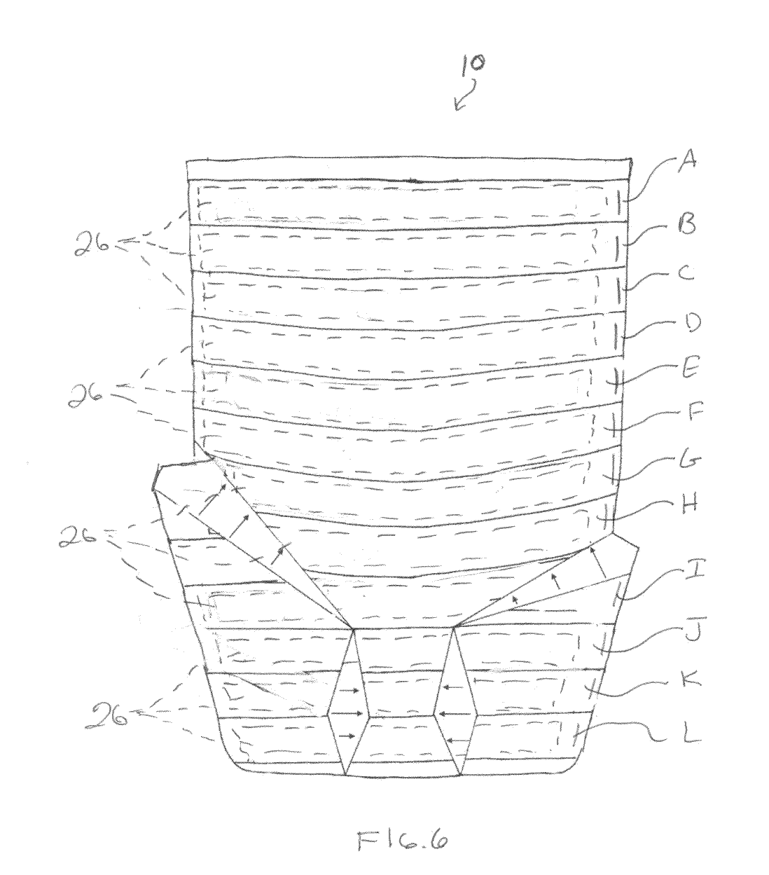

FIG. 5 is a diagrammatic illustration of the cross-section section of a refrigerant bag 26. The refrigerant bag 26 contains a quantity of refrigerant material 54. The refrigerant material 54 is capable of being heated or cooled for the application of heat or cold therapy to the leg. The refrigerant material 54 is a gel material that resists freezing and thus stays fluid when cooled. A suitable refrigerant material 54 can contain polyacrylate, polypropylene glycol, nylon/polyethylene, mixtures thereof, or another suitable refrigerant.

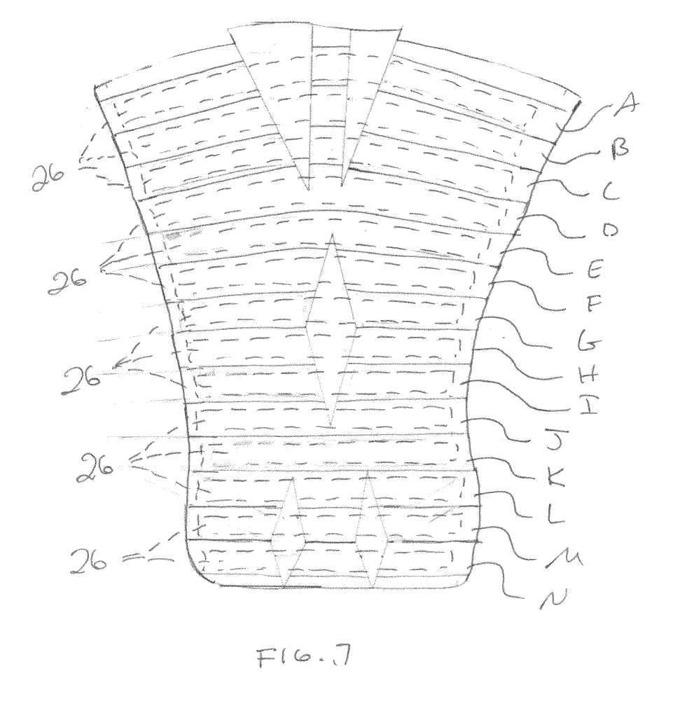

With reference to FIG. 6, there is shown a simplified diagrammatic illustration of leg wrap 10, the quantity of refrigerant material 54 within refrigerant bags 26 can be ranged from a high quantity by weight of refrigerant material in a bag to a low quantity by weight of refrigerant material in a bag. By varying the quantity of refrigerant material 54 contained in each refrigerant bag 26 the time of hot or cold therapy applied at a given location along the length of the leg can be varied. In an embodiment, the refrigerant bag 26 with the highest quantity of refrigerant material can be located at the top of the series of pockets 20, and the refrigerant bag with the lowest quantity of refrigerant material is located at a bottom of the series of pockets. In an embodiment, the refrigerant bag 26 containing the highest weight of refrigerant material 54 contains 180 grams of refrigerant material, and the refrigerant bag containing the lowest weight of refrigerant material contains 90 grams of refrigerant material. In an embodiment, pockets A-I include a refrigerant bag 26 containing 180 grams of refrigerant material, pocket J includes a refrigerant bag containing 130 grams of refrigerant material, and pockets K and L include a refrigerant bag containing contain 90 grams of refrigerant material.

With reference to FIG. 8, there is shown a simplified diagrammatic illustration of leg wrap 10′, the quantity of refrigerant material 54 within refrigerant bags 26 can be ranged from a high quantity by weight of refrigerant material in a bag to a low quantity by weight of refrigerant material in a bag. By varying the quantity of refrigerant material 54 contained in each refrigerant bag 26 the time of hot or cold therapy applied at a given location along the length of the leg can be varied. In an embodiment, the refrigerant bag 26 with the high quantity of refrigerant material is located at the top of the series of pockets 20, and the refrigerant bag with the low quantity of refrigerant material is located at a bottom of the series of pockets. In an embodiment, the refrigerant bag 26 containing the highest weight of refrigerant material 54 contains 200 grams of refrigerant material, and the refrigerant bag containing the lowest weight of refrigerant material contains 150 grams of refrigerant material. In an embodiment, pockets A-D includes a refrigerant bag containing 200 grams of refrigerant material, pocket E includes a refrigerant bag containing 190 grams of refrigerant material, pocket F includes a refrigerant bag containing 150 grams of refrigerant material, pockets G-J includes a refrigerant bag containing 130 grams of refrigerant material, and pockets K-N includes a refrigerant bag containing 150 grams of refrigerant material.

A number of embodiments of the present invention have been described. Nevertheless, it will be understood that various modifications may be made without departing from the spirit and scope of the invention. Accordingly, other embodiments are within the scope of the following claims.

What is claimed is:

1. An equine therapeutic leg wrap for applying either cold or hot compressive therapy to an animal's limb, the equine theraputic leg wrap comprising:
an elongated wrap of a flexible material configured to encircle an animal's limb, said elongated wrap defining a series of transversely extending and longitudinally juxtaposed slender pockets, said elongated wrap including one or more longitudinally extending gussets located intermediate longitudinal side edges of said elongated wrap;
a plurality of refrigerant bags of a slender construction of a flexible material, each of said plurality of refrigerant bags containing a quantity of refrigerant material sealed therein, a single refrigerant bag extending lengthwise in each of said pockets;
a series of transversely extending and longitudinally spaced straps each attached at one end to said elongated wrap and terminating at a free end, each of said straps of a length to encircle said animal's limb;
each of said straps and said elongated wrap having complementary hook-and-loop fasteners for releasably securing said free end of each of said strap to said elongated wrap to secure said elongated wrap to said animal's limb;
wherein the quantity by weight of said refrigerant material in contained in each of said refrigerant bags ranges from a high weight of refrigerant material to a low weight of refrigerant material; and
wherein the refrigerant bag containing the highest weight of refrigerant material is located at a top of said series of pockets, and the refrigerant bag containing the lowest weight of refrigerant material located at a bottom of said series of pockets.

2. The equine therapeutic leg wrap of claim 1, wherein each of said refrigerant bags are divided into separate and vertically sealed longitudinally extending compartments.

3. The equine therapeutic leg wrap of claim 1, wherein said one or more longitudinally extending gussets includes a pair of bottom gussets transversely spaced and longitudinally aligned and being located approximate a bottom end of said elongated wrap.

4. The equine therapeutic leg wrap of claim 3, wherein said one or more longitudinally extending gussets further includes a transversely centered gusset positioned above said pair of bottom gussets, and a pair of top gussets transversely spaced and longitudinally aligned and being located approximate a top end of said elongated wrap.

5. The equine therapeutic leg wrap of claim 4, wherein said pair of top gussets extend from said top end of said elongated wrap.

6. The equine therapeutic leg wrap of claim 1, wherein said refrigerant material is of a gel material.

7. The equine therapeutic leg wrap of claim 1, wherein said refrigerant bag containing the highest weight of refrigerant material contains 200 grams of said refrigerant material, and said refrigerant bag containing the lowest weight of refrigerant material contains 150 grams of said refrigerant material.

8. The equine therapeutic leg wrap of claim 1, wherein said refrigerant bag containing the highest weight of refrigerant material contains 180 grams of said refrigerant material, and said refrigerant bag containing the lowest weight of refrigerant material contains 90 grams of said refrigerant material.

9. The equine therapeutic leg wrap of claim 1, wherein said elongated wrap is about 73 cm in height, and about 56 cm in width when laid open.

10. The equine therapeutic leg wrap of claim 1, wherein said elongated wrap is about 87 cm in height, and about 74 cm in width when laid open.
